(19) United States
(12) Patent Application Publication
(10) Pub. No.: US 2015/0020340 A1
(43) Pub. Date: Jan. 22, 2015

(54) Universal Wiper Blade Cover

(71) Applicant: Barry Moore, Port Charlotte, FL (US)

(72) Inventor: Barry Moore, Port Charlotte, FL (US)

(21) Appl. No.: 14/273,941

(22) Filed: May 9, 2014

Related U.S. Application Data
(60) Provisional application No. 61/856,969, filed on Jul. 22, 2013.

(51) Int. Cl. B60S 1/04

(52) U.S. Cl. CPC B60S 1/0491; B60S 2001/3843
USPC 15/250.361

(57) ABSTRACT

Disclosed is an improved windshield wiper blade cover adapted to install onto existing wiper blades on a vehicle to increase visibility for a driver of the vehicle. The wiper blade cover of the present invention includes an elongated cover member with two terminal ends that secure a wiper blade therebetween and a recessed channel adapted to receive the wiper blade therein. The wiper blade cover further includes a blade member disposed along a bottom portion of the cover member, wherein the blade member has a flat, smooth edge constructed to remove or control the flow of liquid on a windshield surface. The wiper cover of the present invention may be used regularly to replace dull or worn existing wiper blades or in inclement weather to improve visibility while driving.

### CROSS REFERENCE TO RELATED APPLICATION

This application claims the benefit of U.S. Provisional Application No. 61/856,969 filed on Jul. 22, 2013. The above identified patent application is herein incorporated by reference in its entirety to provide continuity of disclosure.

### BACKGROUND OF THE INVENTION

### Field of the Invention

The present invention relates to windshield wiper blade cover devices. More specifically, the present invention pertains to an improved wiper blade cover that can be easily installed by vehicle owners. The wiper cover of the present invention is designed to fit over existing wiper blades, thereby providing an effective means of replacing dull wiper blades.

A windshield wiper is a device used to remove rain and debris from a windshield. Almost all motor vehicles, including trains, aircraft, and automobiles are equipped with wipers. A wiper generally consists of an arm, pivoting at one end with a long rubber blade attached along the length of the arm. The blade is swung back and forth over the windshield, pushing water or debris from its surface. Most automobiles use two synchronized radial type arms, while many commercial vehicles use one or more pantograph arms.

Extended exposure to temperature extremes, ultraviolet rays, ozone, road salt, oil, automatic car washes, and regular use can all contribute to wiper blade wear. It is recommended to change windshield wiper blades every six to twelve months. Factors such as the weather and seasonal environmental conditions, however, may require longer or shorter replacement intervals. Worn wiper blades can limit driving visibility, which is potentially unsafe for a driver to operate a vehicle.

Worn wiper blades can cause streaking, chattering, smearing, or squeaking. Hardened or cracked rubber blades due to exposure to the ultraviolet rays, tree sap, road tar, and automotive chemicals can cause the blades to streak. This causes the bands of water to remain after each wiping stroke, or result in unwiped areas, obstructing or reducing the view of the driver. Additionally, extreme hot or cold temperatures or extended periods of non-use can cause blades to exhibit chatter, as the blades skip and vibrate over the windshield. Moreover, old or worn rubber of the blade can squeak across the windshield.

Replacing or restoring worn windshield wiper blades is difficult, inconvenient, and costly. Installing new windshield wiper blades requires a user to find and purchase a specific size blade to fit the existing windshield wiper blade arm, depending on the make, model, and year of the user's vehicle. Additionally, the wiper's framework that holds the wiper blades and connects thereon are also subject to wear. This can cause the wiper to get bound up or loose, causing the wiper to rattle, skip, or not maintain contact with the windshield. As such, a user may also be required to remove a preexisting connector on the wiper blade arm. Improper installation can damage the wiper blade arm, and the wiper blades can lose their effectiveness.

The present invention is a windshield wiper blade cover adapted to fit over an existing wiper blade that has become worn and dull. In a preferred embodiment, the device comprises an elongated cover member and a blade member comprising rubber or other suitable material such as silicone. The cover member includes two protruding terminal ends that are adapted to hook onto ends of a wiper blade of a vehicle. The cover member further includes an upper wall having a recessed channel that extend from one end to the opposite end of the cover member. The recessed channel receives the existing wiper blade and is press-fitted thereon. Once the wiper blade cover device of the present invention is secured onto the wiper blade, the blade member rests flushly against an exterior surface of a vehicle windshield. Accordingly, the blade member conforms to the windshield shape and maintains superior contact across the entire blade. The present invention is ideal for use on all motor vehicles equipped with wipers.

### Description of the Prior Art

Devices have been disclosed in the prior art that relate to windshield wiper covers designed to fit over existing windshield wipers. These include devices that have been patented and published in patent application publications. Some of these patents describe a windshield wiper glove that protects the windshield wiper from snow and ice while a vehicle is stationary. Another patent describes an insulated cover with a pocket that receives a windshield wiper blade to heat the wiper blade. These devices, however, are designed for protecting the wiper blades from snow and ice while the vehicle is stationary rather than removing water or other debris from the windshield while the vehicle is in operation. The following is a list of devices deemed most relevant to the present disclosure, which are herein described for the purposes of highlighting and differentiating the unique aspects of the present invention, and further highlighting the drawbacks existing in the prior art.

These prior art devices have several known drawbacks. For example, U.S. Published Patent Application Number 2005/0235448 to Richard describes a protective cover for windshield wipers that may be fitted and secured over a windshield wiper to prevent the accumulation of snow and other materials around the wiper while the vehicle is stationary. The apparatus is constructed of waterproof and flexible material designed to fit over and substantially cover a windshield wiper. The apparatus is secured to the wiper via a variety of fastening means. In this way, the apparatus protects the windshield wipers and prevents the wipers from operating improperly due to snow and ice buildup.

Though the windshield wiper cover in Richard may be used while a vehicle is in operation, the windshield wiper cover in Richard lacks a blade member for removing water or debris from the windshield. Accordingly, the device in Richard does not provide an effective means to increase visibility for the user in inclement weather. In contrast, the present invention comprises a cover that fits over an existing wiper blade on a vehicle, and a blade attached thereon. The blade on the present invention is similar to the blade on the existing wiper, thereby allowing a clean sweep of the windshield. Additionally, the present invention is adapted for use on a regular basis or in an emergency situation for clearing the windshield in inclement weather.

Similarly, U.S. Pat. No. 6,070,287 to Kornegay discloses a cover for windshield wiper blade apparatus comprising a cover that is constructed of vinyl, canvas, or other similar material. The cover further includes a sleeve or a pocket adapted to accept a wiper blade therein. The cover protects wipers from premature damage that normally results from exposure to the sun's UV rays. For this reason, the wiper cover disclosed in Kornegay is particularly useful to owners of recreational vehicles who normally store their recreational vehicles outdoors for extended periods of nonuse. In contrast, the present invention is adapted to be installed and employed during the use of a vehicle, particularly when the existing wiper blades are defective and worn from repeated use over time. As such, the present invention comprises a wiper blade that engages the windshield for removing water and debris. Thus, the purpose and design of the wiper cover in Kornegay differs from the present invention.

Another device, U.S. Pat. No. 8,393,046 to Schneider discloses a protective sleeve for a rear window wiper. The protective sleeve is adapted to protect the wiper during a mechanized or automated car wash. The wiper protector comprises a folded sheet of material with an open end for receiving a wiper and a drawstring. The drawstring passes through the sleeve guided by non-marring grommets near the sleeve open end. A plastic drawstring lock maintains tension on the drawstring during use. The device is shaped and constructed to prevent entanglement of car wash mechanisms. However, the Schneider device is limited in that it cannot be used to remove or control the flow of liquid and debris on a windshield. Accordingly, the Schneider device is subsequently removed from a windshield wiper when a vehicle is not engaged in a mechanized or automated carwash. Because the present invention is designed to be used on a regular basis to clear water and debris from the windshield, the present invention includes a cover and a blade member comprising a high-quality rubber or other suitable material such as silicone. Furthermore, the blade member has a flat, smooth edge adapted to remove or control the flow of liquid on a windshield surface.

Yet another device, U.S. Pat. No. 5,412,177 to Clark describes a removable, heated cover for a windshield blade assembly. The device comprises an electrically heated cover for wiper blade assemblies including a cover and an opening for a wiper blade. The electrical elements for heating are disposed in the inner surface of the cover, and are electrically connected to the vehicle electrical system to provide heat that prevents formation of ice on the wiper blade assembly, the wiper blades, and the windshield during cold weather. Once the wiper blade assembly, the wiper blades, and the windshield are sufficiently heated, the device is removed for the normal operation of the windshield wipers. Accordingly, the windshield wipers are not operable while the heated covers are affixed to the windshield wipers. In contrast, the present invention allows a user to operate the windshield wipers while the device is attached thereon. As such, the present invention is suitable for regular use with existing windshield wipers, eliminating the need for a user to detach the device therefrom.

Finally, U.S. Published Patent Application Number 2013/0000802 to Rees discloses a windshield wiper sleeve having an elongated body and a handle thereon. The interior of the elongated body includes an insulated material adapted to proactively heat the wiper arms. In this way, the Rees device prevents a user from having to first remove ice and snow from the wiper blades. Similar to the Clark device, however, the Rees device requires a user to remove the device before driving. Accordingly, the design of the Rees device is not suitable for removing or clearing liquid or debris on a windshield surface.

The present invention discloses a windshield wiper blade cover comprising a cover member adapted to attach onto an existing wiper blade of a vehicle. The windshield wiper blade cover further comprises a blade member having a flat, smooth edge adapted to remove or control the flow of liquid on a windshield surface. The windshield wiper blade cover of the present invention comprises a rubber or rubber-like material that is stretchable and flexible in nature. This improves the versatility of the blade cover with regard to convenient installation of the wiper blade cover. The present wiper blade cover is adapted to fit over an existing wiper blade of various sizes, thereby eliminating the need to remove an existing wiper blade on a vehicle. This is advantageous because the present invention can be installed without a tool or modification of the wiper blade cover, providing convenience to the user. Therefore, the present invention provides for a user with the ability to install a new wiper blade onto existing wiper blades, and increase the ease of installation over currently available replacement wiper blade assemblies.

It is therefore submitted that the present invention substantially diverges in design elements from the prior art, which overcomes the disadvantages of the prior art devices, and consequently it is clear that there is a need in the art for an improvement to existing windshield wiper cover devices. In this regard the instant invention substantially fulfills these needs.

### SUMMARY OF THE INVENTION

In view of the foregoing disadvantages inherent in the known types of windshield wiper blade cover devices now present in the prior art, the present invention provides a new improvement to windshield wiper covers wherein the same can be utilized for replacing existing worn or inoperable wiper blades.

It is therefore an object of the present invention to provide a new and improved windshield wiper blade cover device that has all of the advantages of the prior art and none of the disadvantages.

It is another object of the present invention to provide a windshield wiper blade cover device that is adapted to fit onto existing windshield wiper blades of various sizes to accommodate wiper assemblies on different make, model, and year of a vehicle.

Another object of the present invention is to provide a windshield wiper blade cover device that provides cover member which provides a recessed channel adapted to receive an existing wiper blade therein, and a blade member having a flat, smooth edge adapted to conform to the contour of a windshield surface so that it maintains consistent contact across the entire blade.

Yet another object of the present invention is to provide a windshield wiper blade cover device that can remove water and debris from a windshield of a vehicle, thereby increasing visibility for a driver when operating the vehicle.

Still yet another object of the present invention is to provide a windshield wiper blade cover device that may be installed onto an existing wiper blade without the usage of additional tools.

Still yet another object of the present invention is to provide a windshield wiper blade cover device that is adapted for regular usage or usage during particular emergency situations.

Still yet another object of the present invention is to provide a windshield wiper blade cover device that is cost effective way to replace a worn wiper blade.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front and rear perspective view of the windshield wiper blade cover of the present invention when not in use.

FIG. 2 shows a frontal view of the present invention where the windshield wiper cover is being inserted onto an existing windshield wiper blade on a vehicle.

FIG. 3 shows frontal view of the windshield wiper blade cover of the present invention installed onto an existing windshield wiper blade on a vehicle.

### DETAILED DESCRIPTION OF THE INVENTION

Reference is made herein to the attached drawings. Like reference numerals are used throughout the drawings to depict like or similar elements of the windshield wiper blade cover. For the purposes of presenting a brief and clear description of the present invention, the preferred embodiment will be discussed as used for replacing an existing wiper blade on a vehicle that is worn or dull from usage over time and improving visibility for a driver operating the vehicle. The figures are intended for representative purposes only and should not be considered to be limiting in any respect.

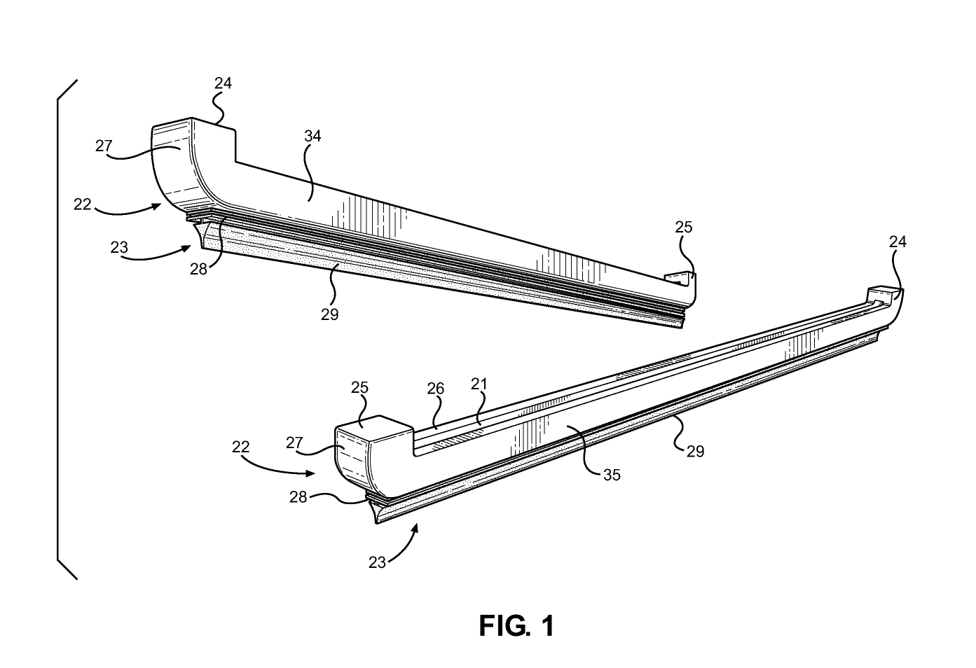

Referring now to FIG. 1, there is shown a front and rear perspective view of the windshield wiper blade cover of the present invention. The wiper blade cover includes an elongated cover member 22 wherein the cover member 22 comprise a high-quality rubber or other suitable material such as silicone that is stretchable and flexible. The cover member 22 is made in one piece, and includes side walls 34, 35, an upper wall 26, and a bottom wall 27. The cover member 22 further includes two terminal ends 24, 25, wherein the two terminal ends 24, 25 protrude upwards above the upper wall 26 of the cover member 22 so as to enclose the ends of a windshield wiper blade on a vehicle when in use. Between the two terminal ends 24, 25 is a recessed channel 21 that is disposed along the upper wall 26 of the cover member 22.

The channel 21 extends along the length of the upper wall 26 such that the channel 21 partially extends into the two terminal ends 24, 25 and parallel to the cover member 22. The channel is a lengthwise cutout or a slit that is adapted to receive the existing wiper blade. Though the cover member 22 is adapted to fit snugly over an existing wiper blade so that it can be positioned securely in place. In some embodiments of the present invention, additional fastening mechanisms may be used for added securement of the wiper blade covers to existing wiper blades. For instance, the cover member 22 may further include ties, clips, laces, or other mechanisms for further securement to the existing blade.

The lower wall 27 of the cover member 22 comprises a blade member 23 attached thereto. The blade member 23 also comprises a rubber material or other suitable material such as silicone that is suitable for pushing debris and water from the exterior surface of a windshield of a vehicle. The blade member 23 comprises an attachment end 28 and a blade end 29, wherein the attachment end 28 comprises a flat surface adapted to rest flushly on the lower wall 27 of the cover member 22. The attachment end 28 may be attached to the lower wall 27 of the cover member 22 via epoxy or other adhesive, by heat sealing, or by any other suitable fastening means. To facilitate removal of water and debris from the windshield, the blade end 29 has a flat, smooth edge adapted to conform to the contour of a windshield surface and maintain consistent contact across the entire blade. In some embodiments of the present invention, the blade 29 may comprise a triangular cross section such that the blade member 23 tapers towards, and forms a point at, the blade end 29. Accordingly, the blade end 29 removes or controls the flow of liquid on a windshield surface when the wiper blade cover is moved across the windshield surface.

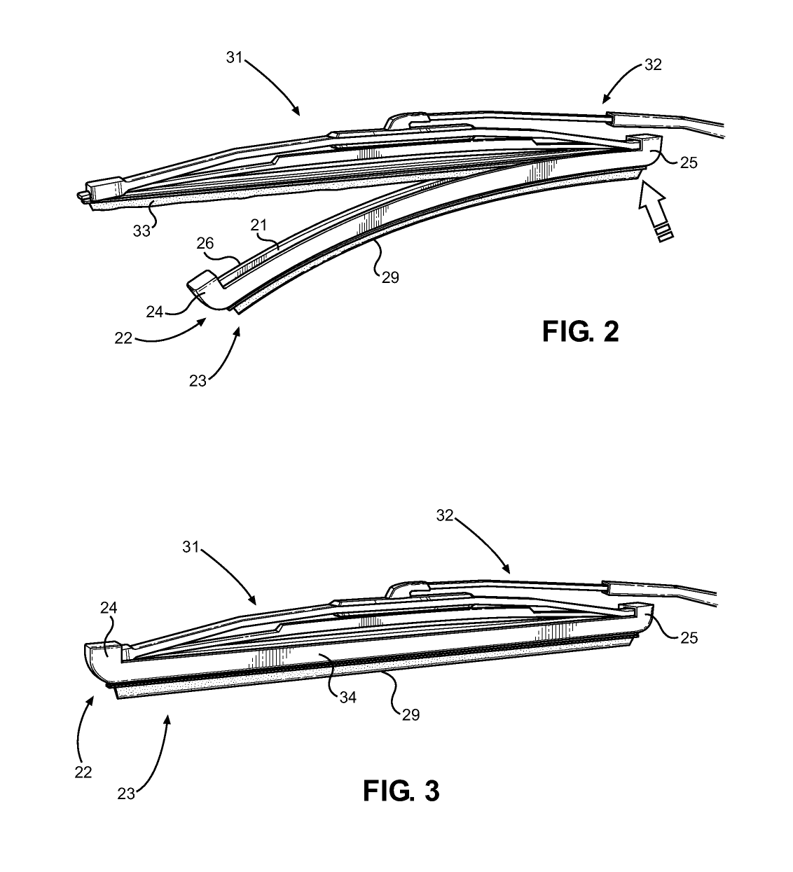

Referring now to FIG. 2, there is shown a frontal view of the present invention where the windshield wiper blade cover is being attached to an existing windshield wiper blade 31 that is disposed on a wiper arm 32 of a vehicle. As shown, the cover member 22 and the blade member 23 of the present invention comprises flexible material that is adapted to bend and stretch over an existing wiper blade 31. The two terminal ends 24, 25 of the cover member 22 provide a protruding portion which fits over two opposing ends of the existing windshield wiper blade 31. In the illustrated view, the terminal end 25 is first hooked over one end of the existing wiper blade 31, and then the remaining portion of the wiper blade cover is pressed onto the wiper blade 31 such that the rubber blade 33 of the wiper blade 31 is inserted into the channel 21 disposed on the upper wall 26. The terminal end 24 is then secured to the opposing end of the existing wiper blade 31, such that the windshield wiper blade cover is securely positioned over the existing wiper blade 31.

Accordingly, the wiper blade cover is adapted to stretch parallel to the wiper blade 31. When stretched, the side walls are brought closely together, and thus the wiper blade cover grips the wiper blade 31 throughout the entire length of the same, and is maintained on the wiper blade 31 with a tight fit; and thus is prevented from gapping or loosening its hold on the wiper blade 31 at any part thereof. As the wiper blade cover is stretched across the wiper blade 31, the rubber blade 33 and the wiper blade 31 are aligned with the channel 21 disposed on the upper wall 26 and inserted therein. The second terminal end 24 is then hooked to the opposite end of the existing wiper blade 31, whereafter the wiper blade cover is press-fitted and the upper wall 26 rests directly against the wiper blade 31. In other embodiments, the wiper blade cover may be snap-fitted or attached using various fastening means.

The terminal ends 24, 25 not only secure the ends of the wiper blade 31, but present sufficient material to prevent the ends of the wiper blade 31 from cutting through the wiper blade cover when the latter is applied to the wiper blade 31 in its stretched state. Moreover, the terminal ends 24, 25 afford finger grasping portions to facilitate installation and removal of the wiper blade cover from the wiper blade 31.

Once affixed, the cover member 22 is securely attached to the existing wiper blade 31, resisting separation or relative sliding during use. The windshield wiper blade cover does not affect the functionality of the wiper arm 32, but acts in place of the existing wiper blade 31. In its operating state, the blade member 23 rests against a vehicle windshield surface similar to the intended position of the underlying wiper blade 31. When the blade member 23 is swung back and forth over the windshield, the blade end 29 pushes water or debris from its surface. Therefore, the present invention does not detract from its goal of removing water or controlling the flow of liquid and debris on a windshield surface. When the windshield wiper blade cover is no longer needed, the wiper blade cover is pulled off of the wiper blade 31 and stored without any inconvenience to the user.

Referring now to FIG. 3, there is shown a frontal view of the windshield wiper blade cover the present invention installed onto an existing windshield wiper blade 31 on a vehicle. The wiper blade cover is resilient and thus snugly and tightly grips the wiper blade 31 when applied thereto, and is held on the wiper blade 31 without the need of additional fastening means. Moreover, the wiper blade cover may be stretched in the direction of its length when being applied to the wiper blade 31, and thus is under tension which serves to hold the wiper blade cover on the wiper blade 31 without additional fastening means.

The windshield wiper blade cover of the present invention is adapted for use with various types of wiper blades 31. Being flexible, the wiper blade cover may be stretched to fit wiper blades 31 of different length, and when applied the wiper blade cover will automatically adjust itself to the length of the wiper blade 31 by reason of its resilient properties. In this respect, the wiper blade cover is not limited to the structure of the wiper blade 31 being installed into, as it can be stretched over wiper blades 31 of various sizes. Therefore, present invention increase the versatility and the ease of installation over existing wiper blades.

The wiper blade cover is simple in construction. It is substantially all in one piece, and is easy to install and remove from the wiper blade 31. Being of resilient material, the wiper blade cover not only readily adjusts itself to the wiper blade 31 when applied thereto, but snugly and tightly fits the same. Thus, the present invention provides an efficient and effective wiper blade 31 to improve the visibility of an operator of a vehicle when the wiper blade cover is swung across a windshield surface of the vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A windshield wiper blade cover, comprising:
an elongated cover member having a first end, a second end, an upper wall, and a bottom wall;
said cover member having a channel extending from short of said first end and ending short of said second end, wherein said channel is a lengthwise cutout disposed along said upper wall of said cover member,
said channel adapted to accept an existing wiper blade of a vehicle therein;
a blade member having a blade end and an attachment end;
said attachment end attached to said bottom wall.

2. The windshield wiper blade cover of claim 1, wherein said first and said second end protrude upward from said upper wall of said cover member.

3. The windshield wiper blade cover of claim 1, wherein said cover member is adapted to removably connect to said wiper blade.

4. The windshield wiper blade cover of claim 1, wherein cover member comprises a rubber material.

5. The windshield wiper blade cover of claim 1, wherein said blade member comprises a rubber material.

6. The windshield wiper blade cover of claim 1, wherein said blade member extends parallel to said cover member from said first end to said second end.

7. The windshield wiper blade cover of claim 1, wherein said blade member has a triangular cross section such that said blade member tapers toward said blade end.
